(19) United States
(12) Patent Application Publication
(10) Pub. No.: US 2004/0159791 A1
(43) Pub. Date: Aug. 19, 2004

(54) Pet/spect nuclear scanner

(76) Inventor: Yaron Hefetz, Herzelia (IL)

Correspondence Address: William H. Dippert, Esq., Reed Smith LLP, 29th Floor, 599 Lexington Avenue, New York, NY, 10022-7650, US

(21) Appl. No.: 10/369,202

(22) Filed: Feb. 19, 2003

(51) Int. Cl. G01T 1/172

(52) U.S. Cl. 250/363.03

(57) ABSTRACT

Apparatus for generating images of a body responsive to photons emitted from one or more radionuclides in the body, comprising:

a pair of gamma ray detectors that generate signals responsive to photons incident thereon; and

circuitry that receives the signals and determines whether a signal generated by one detector is in coincidence with a signal generated by the other detector and processes at least some coincident signals to generate a first image of the patient and process at least some signals that are not in coincidence to generate a second image of the patient.

### FIELD OF THE INVENTION

The invention relates to PET and SPECT nuclear imaging scanners and in particular to nuclear imaging scanners capable of acquiring both PET and SPECT images of a patient.

### BACKGROUND OF THE INVENTION

In nuclear imaging, a radiopharmaceutical that emits radiation is introduced into a patient's body and radiation emitted by the radiopharmaceutical is detected to determine locations and concentration of the radiopharmaceutical in the body. Depending on the particular application and radiopharmaceutical introduced, the detected concentration may be used to generate images of organs and features of the body, monitor body processes such as blood flow to an organ or tag a particular biochemical function. Some radiopharmaceuticals concentrate selectively in tumors and in particular in malignant tumors.

In nuclear imaging methods, referred to as Single Photon Emission Computerized Tomography (SPECT), a radiopharmaceutical comprising a radionuclide that emits a single photon, is introduced into a patient's body. A “SPECT” scanner comprising a suitable gamma camera is used to detect photons radiated by the pharmaceutical and to generate a SPECT image of the patient. The gamma camera is mounted on a suitable gantry and generally comprises a plurality of photon detectors, typically a combination of photomultiplier tubes (PMTs) and scintillator material. A collimator, formed from a highly absorbing material, such as lead, causes an image to form on the scintillator.

For each location in the plane of the scintillator, there is a unique line passing through the location, defined by the collimator and hereinafter referred to as a “detection direction”. A photon originating from the radiopharmaceutical in the patient's body can be incident on a given location of the scintillator only if the photon propagates substantially along a specific detection direction. The photon is absorbed in the scintillator and gives off light, which is detected by a number of PMTs in the region of the location. Different PMTs detect different amounts of light depending on the original energy of the photon and the proximity of the PMT to the absorption location. The PMTs give electronic signals responsive to the amount of light they each detect. The electronic circuits detect the absorption location and thereby the detection direction from the assemblage of the PMT electronic signals with appropriate weighting circuits.

In nuclear imaging referred to as Positron Emission Tomography (PET), a radiopharmaceutical comprising radionuclides that emit positrons is introduced into the patient's body. When a radionuclide emits a positron, the positron and an electron in the patient's body annihilate into two photons at a location close to where the radionuclide emitted the positron. Each of the annihilation photons has an energy of 511 Kev and travels away from where they are created in opposite directions.

The annihilation photons are detected by a gamma camera incorporated in a “PET” scanner. The gamma camera comprises a plurality of detectors situated around the patient. The photon detectors can be in the form a pair or pairs of planar detectors (e.g. Anger cameras or solid state arrays), where the detectors in a pair are situated oppositely. In PET, the photon detectors are generally not equipped with a collimator. A photon annihilation pair is detected when detectors on opposite sides of the patient, and for which a line connecting the detectors passes through the patient, detect photons substantially simultaneously, i.e., within a “coincidence time window”. Alternatively, two planar detectors that are at an oblique angle even a right angle can be used. However, data collection in PET will be less efficient than that for oppositely situated detectors.

A detection direction, along which the detected annihilation photons traveled from where they were created in the patient's body to the regions of the detector in which they are detected is determined by the line that joins said detection regions on opposite sides of the patient that detect the photons. A spatial image of the concentration of the radiopharmaceutical is determined from quantities of annihilation photon pairs that are detected at each of the detection directions and locations defined by the detection regions in the photon detectors.

In many situations it is desirable to image a region of a patient's body or a function thereof using both SPECT radiopharmaceuticals and PET radiopharmaceuticals, i.e., acquire both SPECT and PET images of a person's body at the same time.

U.S. Pat. No. 6,255,655 describes a PET/SPECT scanner for imaging a patient that switches between a SPECT mode of operation to a PET mode of operation so that “PET and SPECT images are immediately sequentially generated very close in time to one another” during imaging of the patient.

U.S. Pat. No. 6,303,935 describes a PET/SPECT imaging system for performing PET and SPECT imaging of a patient simultaneously. The imaging system comprises a “pair of dedicated PET detectors . . . for performing only high energy PET imaging” and “at least one dedicated single photon detector . . . for performing only low energy single photon imaging of the patient.”

The disclosures of the above referenced US patents are incorporated herein by reference.

### SUMMARY OF THE INVENTION

An aspect of some embodiments of the present invention relates to providing a nuclear imaging scanner, hereinafter referred to as a “PET-SPECT” scanner capable of simultaneously acquiring both a PET and a SPECT image of a patient.

An aspect of some embodiments of the present invention relates to providing a PET-SPECT scanner in which a same set of detectors is used for simultaneously detecting PET photons and SPECT photons generated by PET and SPECT radiopharmaceuticals in a patient's body.

An aspect of some embodiments of the present invention, relates to providing a PET-SPECT scanner comprising a controller that determines if signals generated by the detectors are generated responsive to PET photon pairs or SPECT photons and processes the signals to provide respectively PET and SPECT images.

In accordance with an embodiment of the present invention, a PET-SPECT scanner comprises collimators that collimate SPECT photons from a suitable SPECT radiopharmaceutical in a patient's body but is substantially transparent to PET photons from a PET radiopharmaceutical in the patient's body. The controller receives and processes signals generated by the detectors at regions thereof, responsive to photons incident thereon.

It is noted that SPECT photons generally have energies substantially less than the 511 Kev energy that characterizes annihilation pair PET photons. A collimator that collimates SPECT photons and is substantially transparent to PET photons may therefore be formed having septa that are relatively strongly absorbing for relatively low energy SPECT photons but do not substantially absorb the 511 Kev PET photons.

In operation, the PET-SPECT scanner, in accordance with an embodiment of the present invention, is useable to simultaneously acquire data for providing both PET and SPECT images of a patient in whose body both PET and SPECT radiopharmaceuticals are simultaneously present. The controller processes signals generated by detectors in the scanner's gamma camera to determine for each first photon incident on one detector whether there is a second photon incident on an oppositely located detector that is temporally coincident with the first photon. When planar detectors are used, the coincidence measurement is made between events detected on regions of facing detectors.

If there is a coincidence detection, the controller determines whether the first and second photons are annihilation photons generated by annihilation of positrons from the PET pharmaceutical. If so, the photons are used to produce a PET image of the patient. If the controller determines that one of the photons is not a PET photon the controller determines whether the other photon is from the SPECT pharmaceutical and the photon is used to provide a SPECT image of the patient. The scanner, in accordance with an embodiment of the present invention, thereby acquires data for both a PET and a SPECT image of the patient simultaneously.

Optionally, using methods known in the art, the controller processes signals received from the detectors responsive to photons incident thereon to estimate the energy of the incident photons. Optionally, the controller requires that for photons to be determined to be PET or SPECT photons, the photons respectively have energies that are typical of PET or SPECT photons.

There is thus provided, in accordance with an embodiment of the invention, apparatus for generating images of a body responsive to photons emitted from one or more radionuclides in the body, comprising:

a pair of gamma ray detectors that generate signals responsive to photons incident thereon; and

circuitry that receives the signals and determines whether a signal generated by one detector is in coincidence with a signal generated by the other detector and processes at least some coincident signals to generate a first image of the patient and process at least some signals that are not in coincidence to generate a second image of the patient.

Optionally, the gamma ray detectors are planar detectors having sensitive faces that are at an oblique angle, at a right angle or are substantially parallel to each other.

Optionally, the circuitry determines an energy for the detected photons.

In an embodiment of the invention, the one or more radionuclides generates relatively lower energy photons and relatively high energy photon pairs that travel in opposite directions, the apparatus comprising:

a collimator that collimates the lower energy photons and is substantially transparent to the higher energy photons.

Optionally, the circuitry determines an energy for the detected photons. Optionally, based on the energy determination, the circuitry utilizes at least some coincident detected events that are not consistent with the high energy photons in the generation of the second image.

In an embodiment of the invention, the controller generates a SPECT or attenuation compensated SPECT image, as said second image, based on the relatively lower energy photons. Optionally, the controller generates a PET images based on the relatively higher energy coincident photons.

### BRIEF DESCRIPTION OF FIGURES

Non-limiting examples of embodiments of the present invention are described below with reference to a figure attached hereto. Dimensions of components and features in the figure are chosen for convenience and clarity of presentation and are not necessarily shown to scale.

FIG. 1 schematically shows a PET-SPECT scanner, in accordance with an embodiment of the present invention.

### DETAILED DESCRIPTION OF EXEMPLARY EMBODIMENTS

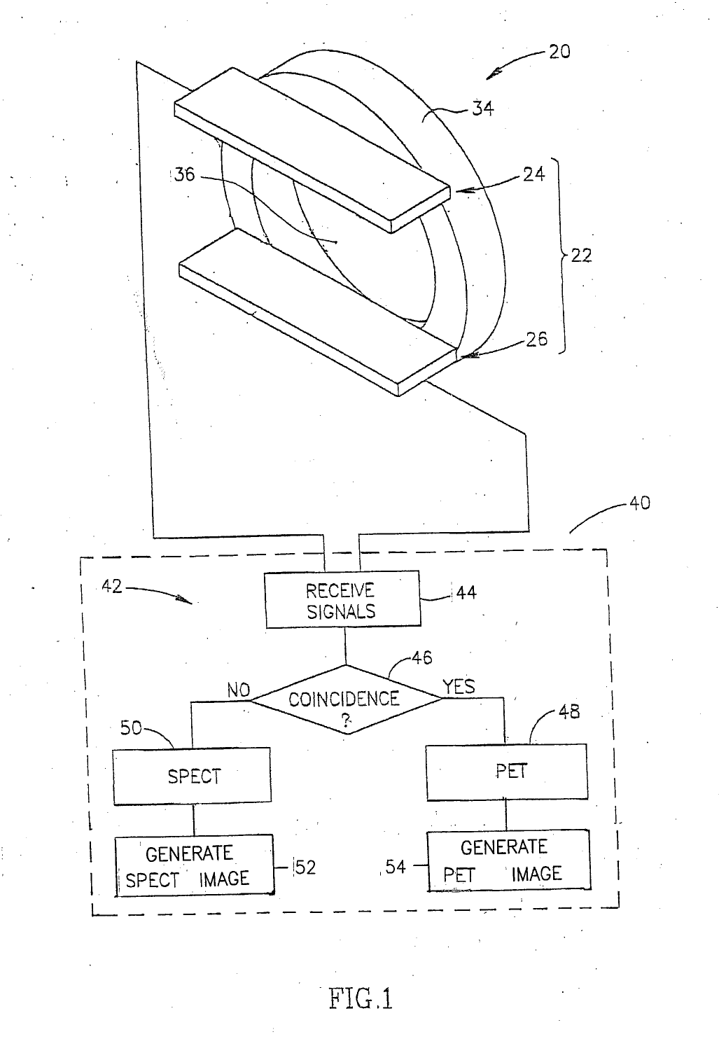

FIG. 1 schematically shows a PET-SPECT scanner 20, in accordance with an embodiment of the present invention. Only elements and features of PET-SPECT scanner 20 that are germane to the present discussion are shown in FIG. 1.

PET-SPECT scanner 20 optionally comprises a gamma camera 22 comprising first and second optionally planar detectors 24 and 26. Detectors 24 and 26 utilize a suitable scintillator or scintillators and include a collimator. Detectors 24 and 26 are optionally mounted to a gantry 34 so that the sensitive face of detector 24 is facing directly or obliquely to that of detector 26 Detectors 24 and 26 are sufficiently displaced from each other and gantry 34 has an aperture 36 sufficiently large so that a patient being imaged by PET-SPECT scanner 20 fit between the detectors and through the aperture. Gantry 34 allows detectors 24 and 26 to be positioned at different angles around the patient.

Details of the construction of detectors 24 and 26 are not shown and the detectors may be constructed using any of various materials, methods and configurations readily available in the art. For example, the photon detectors may be photomultiplier tubes (PMTs) coupled to a single large scintillator plate or direct conversion solid state detectors each coupled to its own scintillator or to a shared scintillator. U.S. Pat. No. 6,255,655, cited above, describes a gamma camera for detecting both PET and SPECT photons having a thallium doped scintillator which is thicker than a scintillator formed from the same material generally used for detecting SPECT photons. U.S. Pat. No. 6,303,935, cited above, describes a PET-SPECT detection system comprising a scintillator sandwich, referred to as a phoswich detector, formed from a layer of lutetium oxorthosilicate (LSO) and ytttrium oxyorthosilicate (YSO). Solid state gamma detection with direct conversion material such as CZT of HgI and others are also now known in the art, and usable in the present invention.

It is also noted that whereas gamma camera 22 is shown comprising two planar parallel detectors 24 and 26, a gamma camera suitable for the practice of the present invention is not restricted to two parallel detectors. For example, a suitable gamma camera may comprise a plurality of pairs of parallel detectors that are aligned so that one detector in each pair is opposite a corresponding detector in the pair of detectors. In addition, lines connecting detector pairs that are not mutually parallel in orientation are also useful in PET image reconstruction and are useful in the practice of the invention.

The collimator in each detector 24 and 26 has septa of a thickness and material that strongly absorb photons having energies typical of photons emitted by radionuclides that are commonly used in SPECT radiopharmaceuticals. These energies are substantially less than 511 Kev, which is the energy of annihilation pair photons generated by PET positron emitter radionuclides. For example, the radionuclide Tc-99m, commonly used in SPECT radiopharmaceuticals emits photons at energy of about 140.5 Kev. On the other hand, the septa of the collimator are sufficiently thin so that the septa are weak absorbers of photons at the PET energy. As a result, the collimator is substantially transparent to PET photons yet operates satisfactorily to collimate SPECT photons. Gamma camera 22 can therefore simultaneously detect SPECT photons from a SPECT radiopharmaceutical in a patient's body along detection directions determined by the collimators of detectors 24 and 26 and PET photons from a PET radiopharmaceutical in the patient's body incident on the detectors along substantially any direction. Optionally, widely spaced septa that absorb PET radiation may be present, as is known in the art.

A controller 40 receives signals generated by the photon detectors comprised in gamma camera 22 responsive to photons from a radiopharmaceutical in the body of a patient being imaged using PET-SPECT scanner 20. In accordance with an embodiment of the present invention, controller 40 comprises circuitry for processing the signals in accordance with a flow diagram 42, shown as part of the controller, to determine if photons that generate the signals are PET photons or SPECT photons. PET-SPECT scanner 20 can therefore be used to simultaneously acquire data for PET and SPECT images of a patient responsive to photons emitted by PET and SPECT radiopharmaceuticals that are introduced into and are simultaneously present in the patient's body. Controller 40 then generates the respective SPECT and PET images from the data.

For example, in operation when imaging a patient having both PET and SPECT radiopharmaceuticals in his or her body, in a block 44 of flow diagram 42 controller 40 receives signals responsive to photons generated by the pharmaceuticals that are incident on detectors 24 and 26. In a decision block 46 controller 40 determines for each received signal generated responsive to a photon incident on one of detectors 24 and 26 whether the signal is coincident with a signal generated responsive to a photon incident on the other of the detectors.

If controller 40 determines that there is a coincidence, the photons that generate the coincidence are determined to be PET photons (block 48) generated by annihilation of a positron emitted by the PET radiopharmaceutical in the patient's body. Controller 40 continues to process the coincident signals in a block 54 to generate therefrom a PET image of the patient.

If on the other hand, the controller determines that there is no coincidence (block 50), the signal received from the detector is determined to be responsive to a SPECT photon emitted by the SPECT radiopharmaceutical in the patient's body. Controller 40 continues processing the signal in a block 52 to generate a SPECT image of the patient. Both the SPECT images and the PET images can be generated from the respective data utilizing any of the many algorithms known in the art.

In some embodiments of the present invention, in addition to determining if there is or is not a coincidence, the controller also determines the energy of the received signals, using methods known in the art to determine if photons that generate the signals have energy consistent with the PET or SPECT photons.

Optionally, if signals that are in coincidence indicate that the photons responsive to which they are generated do not have energy in an appropriate energy range in a neighborhood of 511 Kev, the coincidence is determined to be spurious and the signals are determined to represent SPECT photons.

Optionally, to accept the photons as SPECT photons, energy of the photons determined from the signals must also be in an appropriate energy range in a neighborhood of an energy typical of photons emitted by the SPECT radiopharmaceutical in the patient's body.

In processing signals generated by detectors 24 and 26, in accordance with an embodiment of the present invention, any of various corrections as might be required, such as for example, attenuation, linearity, energy or residual corrections may be applied to the signals.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

1. Apparatus for generating images of a body responsive to photons emitted from one or more radionuclides in the body, comprising:
a pair of gamma ray detectors that generate signals responsive to photons incident thereon; and
circuitry that receives the signals and determines whether a signal generated by one detector is in coincidence with a signal generated by the other detector and processes at least some coincident signals to generate a first image of the patient and process at least some signals that are not in coincidence to generate a second image of the patient.

2. Apparatus according to claim 1 wherein the gamma ray detectors are planar detectors having sensitive faces that are at an oblique angle to each other.

3. Apparatus according to claim 1 wherein the gamma ray detectors are planar detectors having sensitive faces that are at a right angle to each other.

4. Apparatus according to claim 1 wherein the gamma ray detectors are planar detectors having sensitive faces substantially parallel to each other.

5. Apparatus according to claim 1 wherein the circuitry determines an energy for the detected photons.

6. Apparatus according to claim 1 wherein the one or more radionuclides generates relatively lower energy photons and relatively high energy photon pairs that travel in opposite directions, the apparatus comprising:
a collimator that collimates the lower energy photons and is substantially transparent to the higher energy photons.

7. Apparatus according to claim 6 wherein the circuitry determines an energy for the detected photons.

8. Apparatus according to claim 7 wherein, based on the energy determination, the circuitry utilizes at least some coincident detected events that are not consistent with the high energy photons in the generation of the second image.

9. Apparatus according to claim 6 wherein the controller generates a SPECT or attenuation compensated SPECT image, as said second image, based on the relatively lower energy photons.

10. Apparatus according to claim 9 wherein the controller generates a PET image based on the relatively higher energy coincident photons.

11. Apparatus according to claim 7 wherein the controller generates a SPECT or attenuation compensated SPECT image, as said second image, based on the relatively lower energy photons.

12. Apparatus according to claim 11 wherein the controller generates a PET image based on the relatively higher energy coincident photons.

13. Apparatus according to claim 7 wherein the controller generates a SPECT or attenuation compensated SPECT image, as said second image, based on the relatively lower energy photons.

14. Apparatus according to claim 13 wherein the controller generates a PET image based on the relatively higher energy coincident photons.

15. Apparatus according to claim 8 wherein the controller generates a SPECT or attenuation compensated SPECT image, as said second image, based on the relatively lower energy photons.

16. Apparatus according to claim 15 wherein the controller generates a PET image based on the relatively higher energy coincident photons.

17. Apparatus according to claim 6 wherein the controller generates a PET image based on the relatively higher energy coincident photons.

18. Apparatus according to claim 7 wherein the controller generates a PET image based on the relatively higher energy coincident photons.

19. Apparatus according to claim 8 wherein the controller generates a PET image based on the relatively higher energy coincident photons.
